(19) United States
(12) Patent Application Publication
(10) Pub. No.: US 2002/0087452 A1
(43) Pub. Date: Jul. 4, 2002

(54) System, method and program product for improving broker's profits in electronic commerce

(75) Inventor: Nimrod Megiddo, Palo Alto, CA (US)

Correspondence Address: Fitch, Even, Tabin & Flannery, Suite 1600, 120 South LaSalle Street, Chicago, IL, 60603, US

(73) Assignee: International Business Machines Corporation, Armonk, NY (US)

(21) Appl. No.: 09/753,556

(22) Filed: Jan. 4, 2001

(51) Int. Cl. G06F 17/60

(52) U.S. Cl. 705/37; 705/10; 705/80

(57) ABSTRACT

A method, system and program product for brokering sales between parties. An interested party or client, such as a buyer or a seller, requests broker's services. The requesting client provides transactional information to the broker system. A transactional model is constructed for the client from the received parameters. The client transactional model indicates the client's likelihood of participation in a particular transaction. Potential second parties to the transaction, i.e., sellers or buyers, are identified. A proposed transaction is structured to maximize spread. The proposed transaction is offered to both the client and the second parties.

### BACKGROUND OF THE INVENTION

1. Field of the Invention

The present invention generally relates to electronic commerce and, more particularly, to brokered transactions in electronic commerce.

2. Background Description

Electronic commerce (e-commerce) is growing rapidly with millions of transactions occurring over the Internet daily. Buyers and sellers can negotiate sales over the Internet without ever seeing one another. Electronic auctions such as eBay.com are big business.

Even though buyers and sellers can find each other much more easily than before using the Internet, brokers still provide some benefits that cannot be obtained from e-commerce directly. In many areas of e-commerce, sellers are reluctant to post prices and may prefer to enter deals with buyers subject to price and term negotiations. Often, at least one of the parties may wish to remain anonymous. Brokers provide anonymity to both sides of such a transaction and can elevate the level of confidence in the solidity of the particular transaction.

Brokers can facilitate a sale through broker-to-broker transactions by matching seller and buyer for a particular item without the participants ever interacting directly with each other. In some cases, a broker representing the buyer (a “buyer's broker”) interacts with another broker representing the seller (a “seller's broker”). In this type of sales transactions, brokers on either side of the transaction derive income only from the transaction, for example, receiving a commission. A common example of a brokered transaction is a real estate transaction wherein a seller's broker and a buyer's broker split a percentage, typically six percent (6%), of the value of the transaction or sale.

In other brokered transactions, brokers themselves may interact with other brokers, identifying and matching interested parties for a particular transaction. In these brokered transactions, brokers derive income from a transaction by taking a difference between the seller's selling or asking price and the buyer's buying or bid price, i.e., what is known as the “spread.” This is brokered type of transaction frequently done with securities and the broker(s) represent neither party. The broker makes the most money, maximizing the spread by connecting sellers willing to sell at a low price to buyers willing to purchase at a considerably higher price.

Brokers add informational value to a brokered transaction by providing an added level of confidence that the sale will go through. The broker uses independent judgement to evaluate the buyer's ability to make a proposed purchase and to verify that the seller actually has the property that is being offered for sale. Further, a broker can help buyers to identify a larger variety of potential purchases. Sellers benefit by the broker identifying more potential buyers to encourage quicker sales at higher prices. Accordingly, brokers provide an important service in e-commerce.

Since the broker derives income from the spread, it is in the broker's interest to negotiate the lowest selling price that the seller will accept and the highest purchase price that the buyer will pay to maximize the spread.

Thus, there is a need in maximizing the broker's income in brokered transactions.

### SUMMARY OF THE INVENTION

It is therefore the purpose of the present invention to maximize broker's profits;

It is another purpose of the invention to negotiate a transaction between a purchaser and a seller at the lowest selling price and the highest purchasing price for the buyer.

The invention is a computer system, method and program product for negotiating as a broker between a prospective buyer and a prospective seller, exploring possible terms of the deal so as to maximize the spread between the acceptable prices. An interested party or client, such as a buyer or a seller, requests broker's services. The requesting client provides transactional information to the broker system. A transactional model is constructed for the client from the received parameters. The client transactional model indicates the client's likelihood of participation in a particular transaction. Potential second parties to the transaction, i.e., sellers or buyers, are identified. A proposed transaction is structured to maximize spread. The proposed transaction is offered to both the client and the second parties.

### BRIEF DESCRIPTION OF THE DRAWINGS

The foregoing and other objects, aspects and advantages will be better understood with the following detailed preferred embodiment description with reference to drawings in which:

FIG. 1 is an example of an e-commerce management system for managing brokered commercial transactions according to the preferred embodiment of the present invention;

FIG. 2 is a flow diagram showing how buyers enter into the preferred embodiment system obtaining assistance from a broker in purchasing desired items;

FIG. 3 is a flow diagram showing how the deal is negotiated by the preferred embodiment e-commerce system.

### DETAILED DESCRIPTION OF A PREFERRED EMBODIMENT OF THE INVENTION

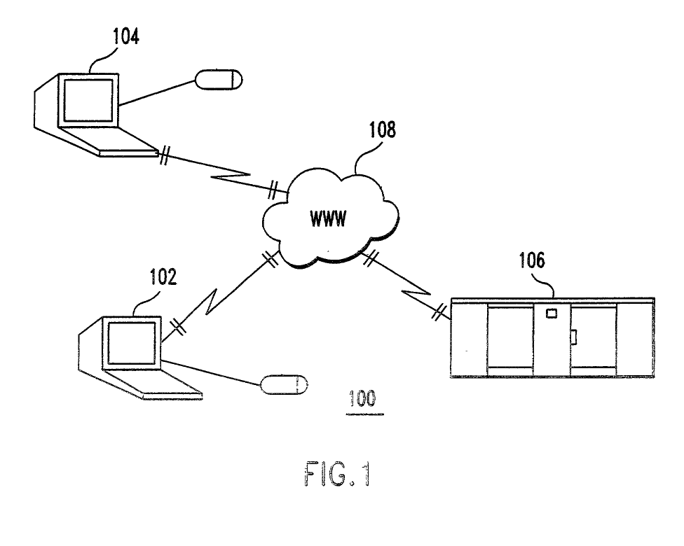

Referring now to the drawings, and more particularly, FIG. 1 is an example of an e-commerce management system 100 for managing brokered commercial transactions according to the preferred embodiment of the present invention. The preferred system 100 includes multiple input terminals 102 and 104 that may be remotely connected to one or more servers 106, which may include a knowledge base of potential buyers and/or suppliers. The terminals 102, 104 and server 106 may be connected together, for example, over what is known as the Internet 108 or the World Wide Web (www).

The preferred embodiment system is most applicable to an above-described brokered transaction and the role of the broker begins when either a buyer or a seller enters the preferred system 100 requesting the broker's help in conducting a transaction. Here the broker is not committed to act in the interest of the buyer or the seller, just to putting together an acceptable deal. Thus, when a transaction is begun, the broker identifies potential parties, i.e., a seller that may supply what the client buyer needs, or a buyer that may buy what the client seller has to offer. Although the present invention is described herein for the buyer retaining the broker's services for example only, it is understood that buyer, seller and terms associated therewith are interchangeable for the purposes of the invention. Thus, a seller retaining the broker's services may be understood also with reference to the drawings, substituting buyer for seller and seller for buyer.

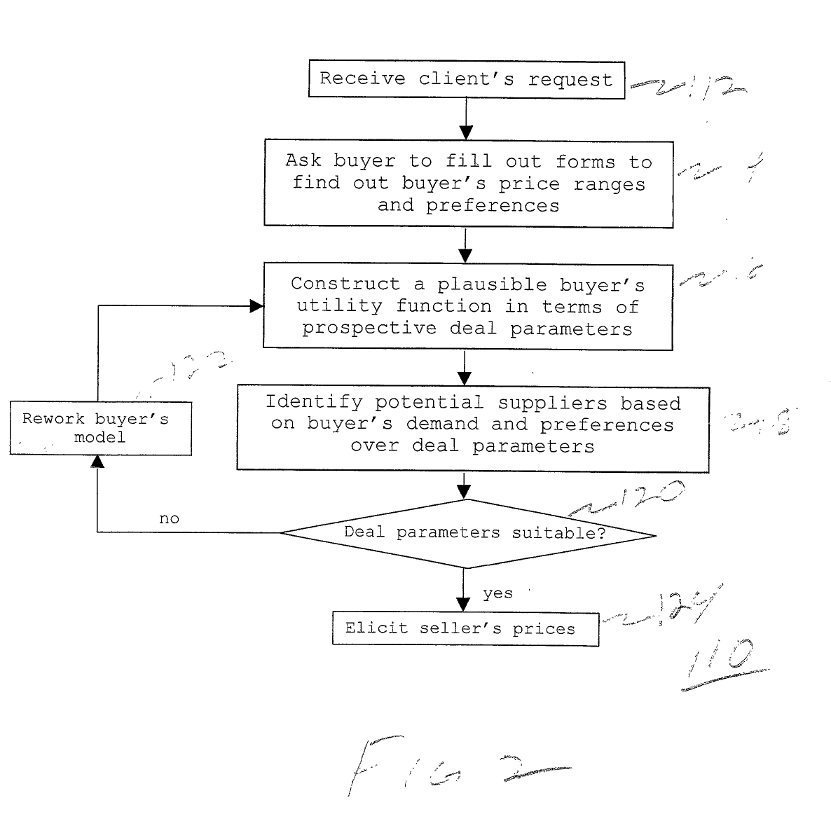

FIG. 2 is a flow diagram 110 showing how buyers enter into the preferred embodiment system 100 obtaining assistance from a broker (i.e., a software broker/agent) in purchasing desired items. First, in step 112, a client/buyer requests the broker's services. Then, in step 114, the broker asks the buyer to fill out forms (i.e., at one of the terminals 102, 104) indicating the buyer's price range and preferences with respect to the item to be purchased. When the buyer fills out the forms in step 114, the buyer provides the broker with maximum prices (caps) that the buyer may be willing to pay for various combinations of items that may be included in the deal. This may be done by asking the buyer to indicate preferences and price ranges on forms provided, for example, on a graphical user interface (GUI). As an example, the buyer may wish to buy 10 trucks with terms including acceptable models, options, financing terms, delivery times, and warranty terms.

Next, in step 116, a plausible buyer's bargain function is constructed in terms of respective deal parameters obtained in step 114. Based on information provided in the forms filled and including any information gathered from follow-up questions, the broker generates a mathematical model of the buyer's bargain with respect to the various terms describing what the buyer wishes to purchase. In an abstract form, if the buyer parameters describing the terms of the deal are x1, . . . , xn, the broker develops the model of the buyer's goal as function B=B(x1, . . . , xn), giving the price the buyer would be willing to pay if the terms of the deal are x1 , . . . , xn. Since the broker does not get the value directly from the buyer, and is paid only when the bargain is complete, the broker relies on the forms to elicit tradeoff limits between terms and constraints around which a deal may be fashioned successfully. Constraints are used herein as a limitation that must be satisfied. So, for example, a buyer may be willing to accept delivery of alternative combinations of products under terms including: in 10 days and warrantied for 90 days; or in 20 days and warrantied for 180 days. Thus, the buyer is willing to trade waiting 10 days of delayed delivery for an additional 90 days of warranty. This information is elicited in the forms and from related follow up questions by asking the buyer to indicate which combination is preferred, e.g., 20 days delivery with 100 days, 110 days, 120 days, etc. This type of question is repeated for each constraint.

So, a regression model may be generated incorporating the value that the buyer attaches to early delivery as a function of the number of days early. Similarly, the broker may attach a value on the buyer's requested warranty terms. If the buyer is an individual or an institution that already has an established e-commerce site with an automatic negotiator, the broker attempts to extract such information by interacting with buyer's site. Preferably, the site has on-line forms through which offers and inquiries can be made. By repeatedly filling out such forms and observing the responses, a software agent can detect the critical thresholds, constraints, and tradeoffs.

Continuing, in step 118, the broker identifies potential suppliers based on the buyer's demand and preferences, considering the full range of deal parameters. In step 120, the deal parameters are checked to determine if they are suitable. Before any proposed bargain is presented to the buyer, the broker works with the buyer's goal model to project what the buyer might be willing to pay for various deals (i.e., prototype bargains), based on the tradeoffs and constraints received as described above. To verify that the model is correct, the prototype bargains are presented to the buyer and the buyer indicates whether the prototypical terms and conditions are suitable. If any of the prototypical bargains are not suitable, then, in step 122, the buyer model is reworked. The buyer may indicate that there are additional constraints that must be met to complete a bargain or, that the assumed tradeoffs need to be revised. This information is provided by the buyer through additional questions with regard to the specific rejected prototype bargain. Then, returning to step 116, using the buyer's revised input, the model is reconstructed.

So, for an example wherein a client wishes to buy 10 trucks, all of the same model, with buyer terms including: x1 indicating the number of days for delivery; x2 indicating the number of months of warranty coverage; and x3 being 0 if the truck make is Ford or 1 if it is a Toyota truck; and, provided in this example, that these two truck makes are the only acceptable selections, then, the transactional model B may be of the form B(x1, x2, x3)=250,000+50,000x3+500x2−1000x1. In other words, the buyer is willing to pay $25,000 for Ford, $30,000 for Toyota, increase the payment $50 per month of warranty per truck, and expects a $100 per day reduction for delayed delivery per truck. In addition, the buyer may also choose to restrict the acceptable delay values of x1 to be between 7 and 21 and, months of warranty x2 to be between 12 and 36, i.e., the warranty must be entered at least 12 months but, that the buyer is not interested in the warranty extending beyond 36 months. If, in step 120, the deal parameters produce suitable results, then, in step 124, the broker elicits seller prices. After receiving prices from potential sellers in step 124, the broker negotiates a deal to optimize broker profit.

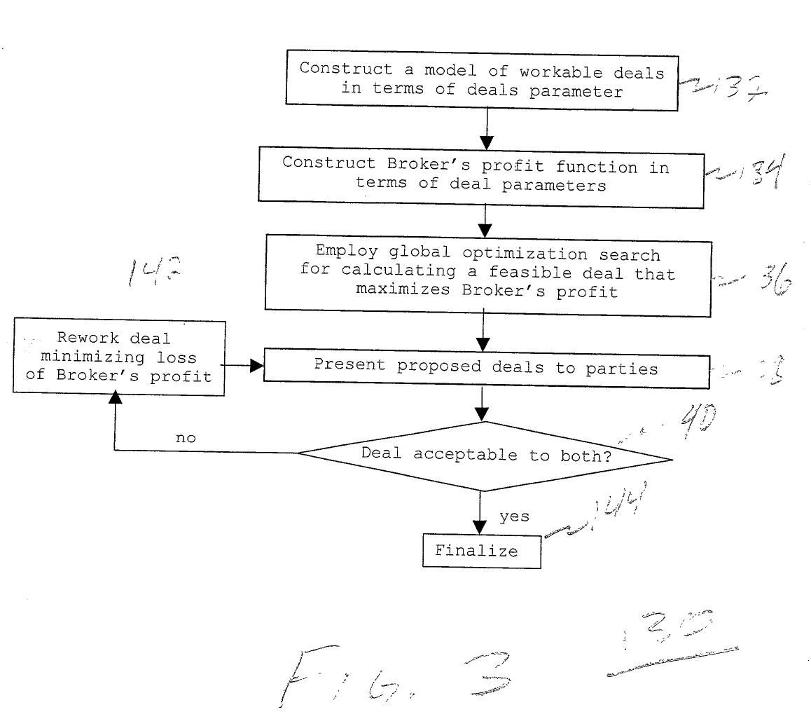

FIG. 3 is a flow diagram 130 showing how the deal is negotiated by the preferred embodiment e-commerce system 100. In step 132, using the buyer's transactional model, the broker constructs a model of workable bargains in terms of acceptable constraints and tradeoffs. Then, in step 134, the broker constructs a broker's profit function in terms of the constraints and tradeoffs. The broker has a knowledge base of potential suppliers through prior transactions or from previously registered sellers. So, based on the buyer's utility function, the seller identifies suitable suppliers and negotiates with them accordingly. The broker develops for each potential supplier a mathematical model of the price S=S(x1 , . . . , xn) at which the seller is expected to be willing to sell with the terms of the deal are given by x1, . . . , xn.

The broker may create a package deal by arranging for different requirements from multiple sellers and suppliers. For example, if a buyer insists on a warranty that the seller does not provide, the broker may obtain the warranty separately by arranging to buy an insurance or service policy. Similarly, the broker may arrange financing and delivery independent of the seller but requested by the buyer. So, the broker's net profit from the bargain (before taxes) is the difference between total payments received from buyers and total costs and expenses including payments to suppliers including sellers and other participants. In some cases the broker may make more profit on arranging to satisfy ancillary requirements of a deal than on the sale itself.

In step 136, employing a global optimization search, the broker searches for a feasible deal that maximizes the broker's profit. A global optimization search refers to an optimization search performed when there is no specific function or domain structure that can be exploited for speeding up the search. So, if the model is linear and the constraints are linear, then “linear programming” is used. Examples of other global optimization techniques for discrete domain searching include “simulated annealing”, “tabu search” and “genetic optimization.” In step 138, the feasible deals identified by the broker as maximizing the spread is presented to the buyer and the seller. In step 140, both parties can accept or reject a bargain. If none of the deals are accepted, then, in step 142, the deal is reworked, again to minimize loss of the broker's profit and, again in step 138, the reworked deal is presented to both parties. Once both parties agree on a deal in step 140, then, in step 144, the deal is finalized.

So, continuing the above truck transaction example, one seller may be willing to sell a Ford for $24,500, a Toyota for $30,100, giving a one month of warranty for $60, and expediting delivery for a cost of $80 a day, i.e., S(x1, x2, x3)=24,5000+56,000x3+600x2−800x1. Furthermore, the seller may restrict x2 to be between 0 and 24 and x1 to be between 15 and 30. The broker can then propose to the parties (without the parties having direct contact with one another) a deal in terms of x1, x2, x3, wherein B(x1 , x2, x3)−S(x1, x2, x3) is maximized subject to x3 being equal to either 0 or 1, 12<=x2 <24, and 7<=x1 <=15.

If during the negotiation, the broker identifies more than one potential seller, the broker constructs a function S=S(x1, . . . , xn) that reflects the possibility of splitting the order among several sellers, and maximizes broker profit accordingly. Further as indicated above, the buyer and seller functions B and S are not necessarily linear. Different types of functions may be constructed for different markets. For example, the function may be piecewise linear, i.e., the feasible domain is partitioned into subdomains with different linear functions on different subdomains. Also, quadratic functions, exponential or logarithmic may be used. Accordingly, spread and, correspondingly, broker profit has been maximized using the transactional system and method of the present invention.

While the invention has been described in terms of preferred embodiments, those skilled in the art will recognize that the invention can be practiced with modification within the spirit and scope of the appended claims.

What is claimed is:

1. A method of brokering sales between parties, said method comprising the steps of:
a) receiving request for broker's services from a client;
b) requesting transactional information from said client for said brokered services;
c) constructing a client transactional model from said received parameters, said client transactional model indicating a likelihood of said client's participation in a transaction;
d) identifying potential second parties to said transaction; and
e) eliciting participants to said transaction from said identified second parties, whereby said transaction is structured to maximize spread.

2. A method of brokering sales as in claim 1 wherein after the step (c) of constructing the client transactional model, said method further comprising the step of:
c1) presenting modeled transactions to said client, acceptance of said modeled transaction determining whether parameters of said transaction are suitable.

3. A method of brokering sales as in claim 2, wherein if parameters of said transaction are determined to be unsuitable in step (c1), said method further comprising the step of:
c2) reworking said transactional model; and
c3) repeating step (c1).

4. A method of brokering sales as in claim 3 wherein said client is a prospective buyer.

5. A method of brokering sales as in claim 3 wherein said client is a prospective seller.

6. A method of brokering sales as in claim 3 further comprising the steps of:
f) constructing a workable deal model responsive to said transactional model;
g) identifying deals likely to be accepted by said client and at least one identified second party responsive to said transactional model and said workable deal model; and
h) presenting identified deals having the largest spread to said client and each said identified second party.

7. A method of brokering sales as in claim 6 wherein when said deal is rejected by said client or all identified second parties, said method further comprising the step of:
j) reworking said deal, whereby reduction of profit to said broker is minimized in said reworked deal; and
k) presenting said reworked deal to said client and each said identified second party.

8. A method of brokering sales as in claim 6 where step (g) of identifying deals likely to be accepted comprises the steps of:
i) constructing a broker's profit function of said received parameters;
ii) employing a global optimization search for identifying a feasible deal that maximizes spread; and
iii) presenting proposed deals to said client and identified second parties.

9. A computer program product brokering sales, said computer program product comprising a computer usable medium having computer readable program code thereon, said computer readable program code comprising:
computer readable program code means for receiving request for broker's services from a client;
computer readable program code means for requesting transactional information from said client for said brokered services;
computer readable program code means for constructing a client transactional model from said received parameters, said client transactional model indicating a likelihood of said client's participation in a transaction;
computer readable program code means for identifying potential second parties to said transaction; and
computer readable program code means for eliciting participants to said transaction from said identified second parties, whereby said transaction is structured to maximize spread.

10. A computer readable program code means for brokering sales as in claim 9 further comprising:
computer readable program code means for presenting modeled transactions to said client, acceptance of said modeled transaction determining whether parameters of said transaction are suitable.

11. A computer readable program code means for brokering sales as in claim 10 further comprising:
computer readable program code means for constructing a workable deal model responsive to said transactional model;
computer readable program code means for identifying deals likely to be accepted by said client and at least one identified second party responsive to said transactional model and said workable deal model; and
computer readable program code means for presenting identified deals having the largest spread to said client and each said identified second party.

12. A computer readable program code means for brokering sales as in claim 11 wherein computer readable program code means for identifying deals likely to be accepted comprises:
computer readable program code means for constructing a broker's profit function of said received parameters;
computer readable program code means for employing a global optimization search for identifying a feasible deal that maximizes spread; and
computer readable program code means for presenting proposed deals to said client and identified second parties.

13. A system for brokering sales between parties, said system comprising:
means for receiving request for broker's services from a client;
means for requesting transactional information from said client for said brokered services;
means for constructing a client transactional model from said received parameters, said client transactional model indicating a likelihood of said client's participation in a transaction;
means for identifying potential second parties to said transaction; and
means for eliciting participants to said transaction from said identified second parties, whereby said transaction is structured to maximize spread.

14. A system for brokering sales as in claim 13 further comprising:
means for presenting modeled transactions to said client, acceptance of said modeled transaction determining whether parameters of said transaction are suitable.

15. A system for brokering sales as in claim 13 further comprising:
means for constructing a workable deal model responsive to said transactional model;
means for identifying deals likely to be accepted by said client and at least one identified second party responsive to said transactional model and said workable deal model; and
means for presenting identified deals having the largest spread to said client and each said identified second party.

16. A system for brokering sales as in claim 15 further comprising means for reworking said deal to minimize reduction of profit to said broker.

17. A system for brokering sales as in claim 15 wherein means for identifying deals likely to be accepted comprises:
means for constructing a broker's profit function of said received parameters;
means for employing a global optimization search for identifying a feasible deal that maximizes spread; and
means for presenting proposed deals to said client and identified second parties.
